(19) United States
(12) Patent Application Publication
(10) Pub. No.: US 2011/0225058 A1
(43) Pub. Date: Sep. 15, 2011

(54) MESSAGING INCLUDING VALUE ACCOUNT CONVERSION

(76) Inventors: Barbara E. Patterson, South San Francisco, CA (US); Glenn Leon Powell, Fremont, CA (US); Jeffrey Morris Sachs, Foster City, CA (US)

(21) Appl. No.: 13/038,637

(22) Filed: Mar. 2, 2011

Related U.S. Application Data
(60) Provisional application No. 61/310,998, filed on Mar. 5, 2010.

(51) Int. Cl. G06Q 20/00; G06Q 40/00

(52) U.S. Cl. 705/17; 705/44; 705/21

(57) ABSTRACT

A system, method, and computer-readable storage medium configured to facilitate, for example, point-of-sale check approval in real-time. The system converts a demand type payment transaction into a payment card transaction. A cardholder database contains a cardholder record. The cardholder record includes a demand account and payment card information of a cardholder. A network interface receives point-of-service transaction data. A transaction processor correlates the user with the cardholder record, and generates an authorization request message which is sent to an issuer for approval.

### CROSS-REFERENCES TO RELATED APPLICATIONS

This application is a non-provisional of and claims the benefit of the filing date of U.S. Provisional Patent Application No. 61/310,998, filed on Mar. 5, 2010, which is herein incorporated by reference in its entirety for all purposes.

### BACKGROUND

In some instances, when consumers shop at a merchant, they pay using a personal check. At a “point-of-sale” (POS), check verification services use American Bankers Association (ABA) number routing. The American Bankers Association number, often referred to as the “transit routing number,” is the nine-digit electronic address of a financial institution. The ABA number is encoded in the Magnetic Ink Character Recognition (MICR) line of all checks, and is assigned to each financial institution and each branch office of that financial institution. The merchant scans the check and transmits MICR data to process transaction messages. While banks can electronically transmit the check data, the majority of check verification is accomplished in batch and may be significantly delayed. Because check fund verification does not occur in real time, a merchant takes significant risk in accepting personal checks.

Further, developing a system to conduct real-time point-of-sale check verification can be an expensive endeavor, since this can require all banks to change their internal systems to accommodate for check authorization processing. In addition, many bank consumers have multiple demand deposit type accounts. Even if the infrastructure of a check authorization processing system could be set up at all issuers, there is no current mechanism by which each of the consumer's accounts can be linked to such check authorization processing system.

Embodiments of the invention address these and other problems.

### BRIEF SUMMARY

Aspects of the embodiments of the present invention relate in general to improved systems and methods for processing payments. Such improved systems improve the speed of transactions and can also reduce fraud. With regard to fraud reduction, when requests to withdraw funds from demand accounts are verified in real time, the likelihood that transactions would be declined for insufficient funds is significantly reduced. This also improves processing speed as well, because the number of unauthorized transactions conducted by the system will be reduced.

Aspects include a point-of-sale check-to-card conversion apparatus, system, method and computer-readable storage medium configured to facilitate point-of-sale check approval in real-time. Although check-to-card conversions are described in detail, as explained below, embodiments of the invention are not limited to check to card conversions. Embodiments of the invention can combine the use of any suitable demand account identifier with a card based authorization process. Further, embodiments of the invention can apply to normal ACH or other demand account processing.

Specific embodiments of the invention may refer to value accounts and value account identifiers. Values accounts may include demand accounts such as checking and savings accounts, while value account identifiers may include checking and savings account numbers.

One embodiment of the invention is directed to an apparatus comprising an account holder database configured to contain an account holder record, the account holder record including value account information comprising a value account identifier for a value account of a user and issuer account information comprising an issuer account identifier of the user. The apparatus may further comprise a network interface configured to receive value account transaction data, the point-of-service value account transaction data including the value account identifier and a transaction amount. It may further comprise a transaction processor configured to correlate the user with the account holder record, and to generate an authorization request message including the issuer account identifier, the value account identifier and the transaction amount. The network interface is further configured to transmit the authorization request message to an issuer for approval.

Another embodiment of the invention is directed to a method comprising receiving value account transaction data via a data communications network, the value account transaction data including a value account identifier associated with a value account of a user and a transaction amount, correlating the user with an account holder record in an account holder database, the account holder record including a value account identifier of the user and issuer account information comprising an issuer account identifier of the user, generating an authorization request message including the issuer account identifier, the value account identifier, and the transaction amount, and transmitting, via a network interface, the authorization request message to an issuer for approval.

Another embodiment of the invention is directed to an apparatus comprising a cardholder database configured to contain a cardholder record, the cardholder record including a value account of a user and payment card information of the user. The apparatus also includes a network interface configured to receive value account transaction data, the point-of-service value account transaction data including an account identifier for the value account of the user and a transaction amount, and a transaction processor configured to correlate the user with the cardholder record, and to generate a payment card authorization request message including the value account identifier and the transaction amount. The network interface is further configured to transmit the payment card authorization request message to the payment card issuer for approval.

Another embodiment of the invention can be directed to a method. The method may comprise receiving value account transaction data via a data communications network, the value account transaction data including a value account identifier associated with a user and a transaction amount, correlating the user with a cardholder record in a cardholder database, the cardholder record including a value account identifier of the user and payment card information of the user, generating a payment card authorization request message including the payment card identifier, the value account identifier, and the transaction amount, and transmitting, via a network interface, the payment card authorization request message a payment card issuer for approval.

These and other embodiments of the invention are described in further detail below.

### BRIEF DESCRIPTION OF THE DRAWINGS

FIG. 1 illustrates an embodiment of a system configured facilitate point-of-sale check approval in real-time.

FIG. 2 illustrates a system with a detailed view of a payment processor configured facilitate point-of-sale check approval in real-time.

FIG. 3 shows a Web page that can be viewed by a user during an enrollment process.

FIG. 4 shows a schematic illustration of linkages between a payment card accounts and various demand accounts.

FIG. 5 shows a system that can be used to conduct a purchase transaction using the real-time demand authorization method according to an embodiment of the invention.

FIGS. 6-7 show flowcharts illustrating methods according to embodiments of the invention.

FIG. 8 shows a diagram of a computer apparatus.

FIG. 9(a) shows a schematic illustration of data elements that can be present in a transaction request message including demand account transaction data, which is sent from a merchant's access device to a payment processor.

FIG. 9(b) shows a schematic illustration of data elements that can be present in an authorization request message that is sent from the payment processor to the payment card issuer.

FIG. 10 shows a depiction of a paper check.

### DETAILED DESCRIPTION

An embodiment of the invention can begin with a user presenting a paper check at the POS terminal to a merchant to pay for a product or service. The merchant transmits POS check information (e.g., ABA routing number, account information, a checking account number from the MICR line, transaction amount, etc.) to the merchant's bank (i.e., acquirer). The acquirer forwards the parsed or non-parsed POS check information to a payment processor (e.g., Visa Integrated Payments System). Alternatively, the merchant may transmit the POS check information directly to the payment processor. The POS check information along with optional transaction amount information, can be an example of demand account transaction data.

Upon receipt of the POS check information, the payment processor determines whether the financial institution affiliated with the check (i.e., drawee or issuer) is a card conversion participant. If the drawee does not participate in the card conversion service, then an error message or a message indicating that the drawee is a non-participant can be transmitted to the acquirer or merchant.

If the payment processor determines that the issuer is a card conversion participant, then the payment processor correlates the checking account (parsed from the MICR line of the check) with a specific cardholder by accessing a cardholder database (CDB). The CDB is an example of an account holder database. The CDB indexes and stores the cardholder information including a customer's payment card number and checking account information. The payment processor then generates a card transaction request with the customer's payment card number, and places the checking account number into a transaction message and forwards request to the card issuer. Stated differently, a payment card authorization request message including the payment card number and the check information (including the ABA routing number, check number, account number, and transaction amount) is generated.

The card issuer then receives the payment card authorization request message. The payment card authorization request message may further comprise a processing code that identifies the transaction as a check request (e.g., conversion, conversion with verification or guarantee) and actual account number in the message. The card issuer, using a computer apparatus, then selects the checking account number and makes an authorization decision. For example, the computer apparatus at the card issuer may determine that there are sufficient funds in the checking account, and may further determine that the transaction is not likely to be fraudulent. The card issuer then transmits a payment card authorization response message including the authorization decision back to the payment processor. The payment card authorization response message may indicate that the transaction has been approved by the issuer. After the issuer provides approval, the issuer may then lock down the funds in the checking account, and the merchant can be assured that it will be paid.

The payment processor, upon receiving the payment card authorization response message, converts the transaction back into a POS check message (with no payment card number) and forwards the response to the merchant. Then the merchant can complete the sale with the user.

Embodiments of the present invention provide advantages over the currently available POS check service. The current POS check service uses American Bankers Association (ABA) routing number and account number in the Magnetic Ink Character Recognition (MICR) data on the check to process a transaction. While the banks can convert paper checks to electronic checks online, the majority of conversion is done in batch. Further, developing a system to gain online access to the DDA (demand deposit account) system can be expensive and requires issuer participation. In embodiments of the invention, however, an existing infrastructure for a card-based transaction (which is already set up to process debit or credit transactions online, real-time) can be used to convert paper checks into card based transactions to approve paper check transactions.

Furthermore, in the conventional POS check system, a check card is only linked to the primary account (e.g., a checking account) and does not allow an account holder to access other accounts (e.g., a money market account) at the point of sale. In embodiments of the present invention, however, multiple accounts can be associated with a single card for the account holder, and this system would allow the account holder to present a check from any accounts to complete a transaction at a point of sale.

Additional technical advantages include the reduction in fraud, because the real time authorization that is present in embodiments of the invention reduces the likelihood of fraud in demand account payment processing. Further, in embodiments of the invention, the overall system is more efficient, because number of transactions that are declined for insufficient funds is reduced. Merchants need not deal with problems relating to insufficient funds.

One aspect of the present invention includes the realization that point-of-sale check approval may be accomplished using an existing infrastructure through converting the check payment transaction into an Automatic Teller Machine (ATM) or other payment card transaction. In such a system, the user has both a checking account (or other type of DDA or demand deposit type account) and a payment card account (typically at the same issuer), which allows the system described herein to leverage off of an existing card payment network infrastructure. The system minimizes the amount of infrastructure changes needed to authorize and/or verify a point-of-sale check transaction in real-time. Further, although card accounts are discussed in detail, embodiments of the invention may also include virtual accounts.

Prior to discussing the specific embodiments of the invention, a further description of some terms can be provided for a better understanding of embodiments of the invention.

A “payment card” can include any suitable card including a credit card, debit card, or charge card.

A “value account” may include any suitable account in which value is present or can be provided. For example, a value account may be a demand account, or a credit account.

A “value account identifier” may include any suitable mechanism for identifying a value account. It may be in the form of letters, numbers, etc., and may have any suitable length.

A “demand account” may include any suitable account in which funds may be requested upon the demand of the account holder, who may be a user. Examples of demand accounts include checking accounts, money market accounts, and brokerage accounts. It may also include accounts with points or other suitable form of value.

A “demand account identifier” may include any suitable mechanism for identifying a demand account. It may be in the form of letters, numbers, etc., and may have any suitable length.

A “demand account transaction indicator” may include any suitable data that indicates that the transaction is intended to be conducted using a demand account. The demand account transaction indicator may be a check type transaction indicator, and may take any suitable form. For example, a demand account transaction indicator can simply be a code (e.g., the number “12”) to indicator that the transaction being conducted is to use funds from a demand account to conduct the transaction.

An “authorization request message” may be a message that includes an issuer account identifier. The issuer account identifier may be a payment card account identifier associated with a payment card. The authorization request message may request that an issuer of the payment card authorize a transaction. An authorization request message according to an embodiment of the invention may comply with ISO 8583, which is a standard for systems that exchange electronic transactions made by cardholders using payment cards, or other electronic data interchange formats. A “transaction request” may also be an authorization request message in some embodiments of the invention.

An “authorization response message” may be a message that includes an authorization code, and may typically be produced by an issuer. A “transaction response” may be an authorization response message in some embodiments of the invention.

A “server computer” can be a powerful computer or a cluster of computers. For example, the server computer can be a large mainframe, a minicomputer cluster, or a group of servers functioning as a unit. In one example, the server computer may be a database server coupled to a Web server.

### I. Enrollment

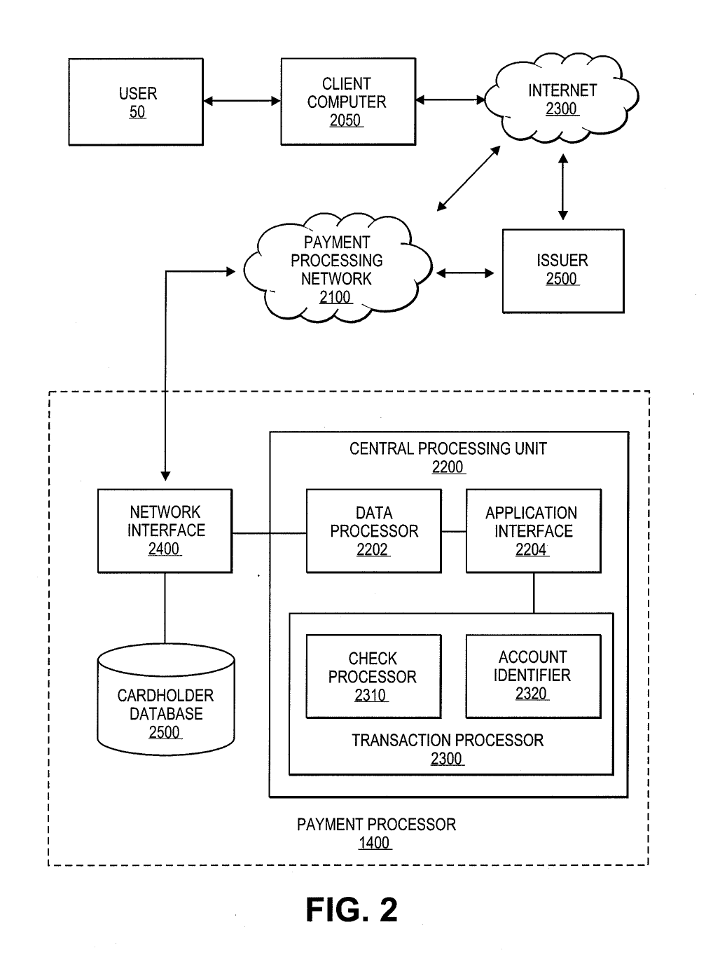

FIG. 2 shows a block diagram of a system that can be used by a user to register account preferences. The system includes a user 50 that can use a client computer 2220 to contact an issuer 2500 of a payment card (not shown)) held by the user 50. The issuer 2500 and the client computer 2200 may communicate with each other through a communications network such as the Internet 2300.

The issuer 2500 may communicate with a payment processing network 2200 which may be associated with a payment processor 1400. In FIG. 2, the payment processor 1400 may comprise a central processing unit 2200, coupled to a network interface 2400 and a cardholder database 2500. The central processing unit 2200 may comprise a data processor 2202, coupled to an application interface 2204. The application interface may also be coupled to a transaction processor 2300. The transaction processor 2300 may comprise a check processor 2310 and an account identifier 2320.

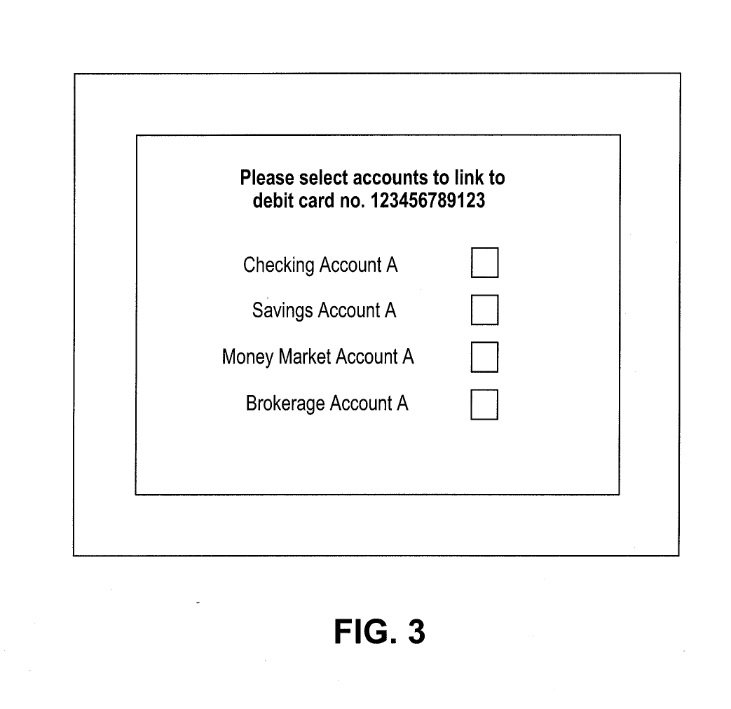

During the enrollment processing, the user 50 may view a Web page such as the one shown in FIG. 3 on the client computer 2200. The Web page may be on a Website (not shown) run by the issuer 2500, central processing unit 2200 or the payment processing network 2100. The Web page may allow the user 50 to select and link one or more demand type accounts (e.g., a checking, savings, money market, or brokerage account) with a payment card account. In the illustrated embodiment, the user 50 may choose to link his checking account and savings account to his payment card account number.

The demand account selection information may then be transmitted to the payment processor 1400 via the Internet 2300 and the payment processing network 2220. This information may then be stored in the cardholder database 2500.

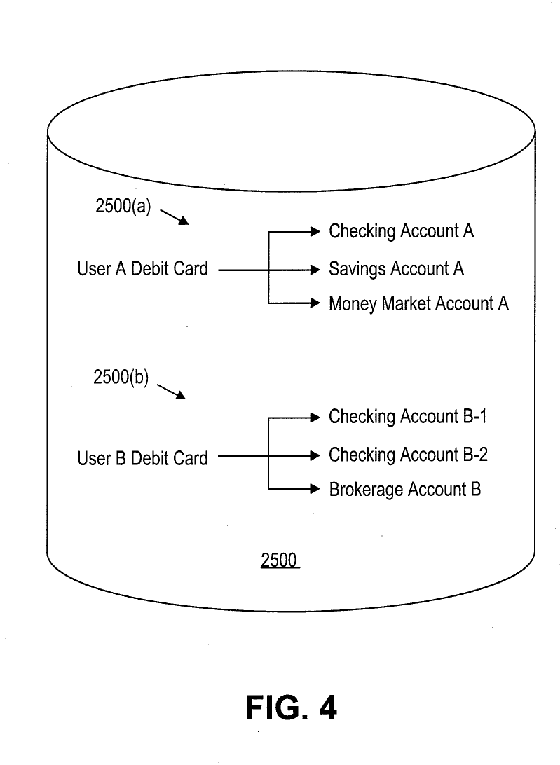

A depiction of the linking of payment card information (an example of issuer account information) to different combinations of demand accounts is shown in FIG. 4. As shown in FIG. 4, user A may have a debit card and this may be linked to a checking account A, a savings account A, and a money market account A. User B may have a credit card and may link the credit card to Checking Account B-1, Checking Account B2 and Brokerage Account B. Thus, as illustrated in FIG. 4, a single payment card account may be linked to one, or one or more demand accounts.

It is apparent that the database 2500 may hold different account holder (e.g., cardholder) records. For example the database 2500 can store demand account information for a demand account (e.g., checking account A), which can be a first account. Such information may include a demand account identifier (e.g., a checking account number for checking account A), which can be a first demand account identifier. The account holder record can further comprise a second demand account identifier (e.g., savings account number A) associated with the user, where both the first and the second demand account identifiers are linked to an issuer account identifier (e.g., user A debit card account number). The issuer account identifier can be a payment card account number.

### II. Transaction Processing Systems

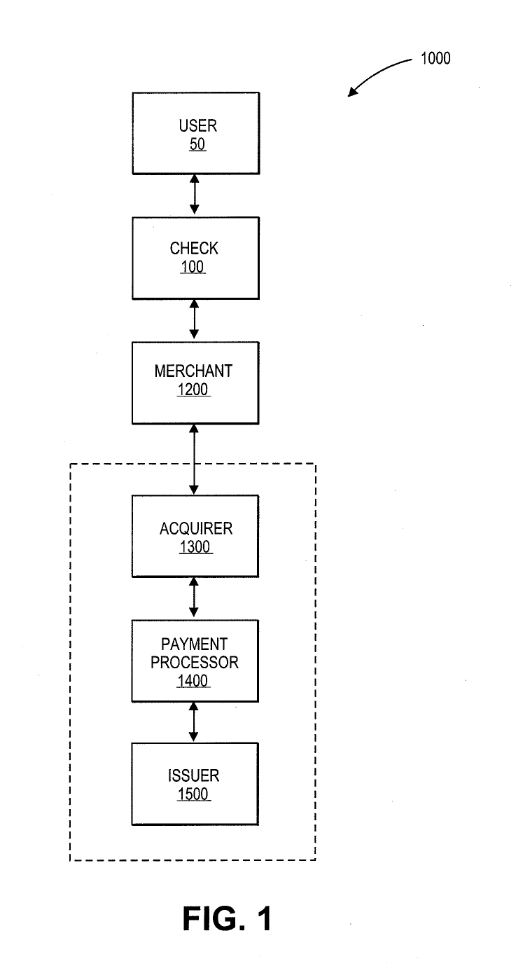

Turning to FIG. 1, system 1000 is configured to facilitate real-time point-of-sale check approval, constructed and operative in accordance with an embodiment of the present invention.

When the user 50 (e.g., a consumer or a cardholder) uses the check 100 at a merchant 1200 to pay for a product or service in real-time, the merchant 1200 contacts an acquirer 1300 (for example, a commercial bank) to determine whether the user is creditworthy or the account has sufficient funds on the card to pay for the transaction. The acquirer 1300 forwards the details of the payment transaction to a payment processor 1400 for processing.

The payment processor 1400 may include any suitable payment network configured to facilitate real-time point-of-sale check approval. A server computer (or other suitable computational apparatus) associated with the network of the payment processor 1400 identifies the payment transaction as a point-of-sale check transaction, and identifies the user 50 as a participant in a real-time check approval transaction. The user 50 may have previously enrolled in this service using any suitable mechanism and in any suitable manner.

The server computer in the payment processing network can access a cardholder database to identify a drawee account. Once this is done, a payment card authorization request message including checking account information is then created. The transaction is forwarded to the issuer 1500 (or to another server computer operated by the issuer 1500) to determine whether a check 100 has enough funds to allow the transaction. Internal details of payment processor 1400 are discussed below.

The issuer 1500 may be any payment card issuer. In some instances, issuer 1500 may also be the banking institution on which check 100 is drawn.

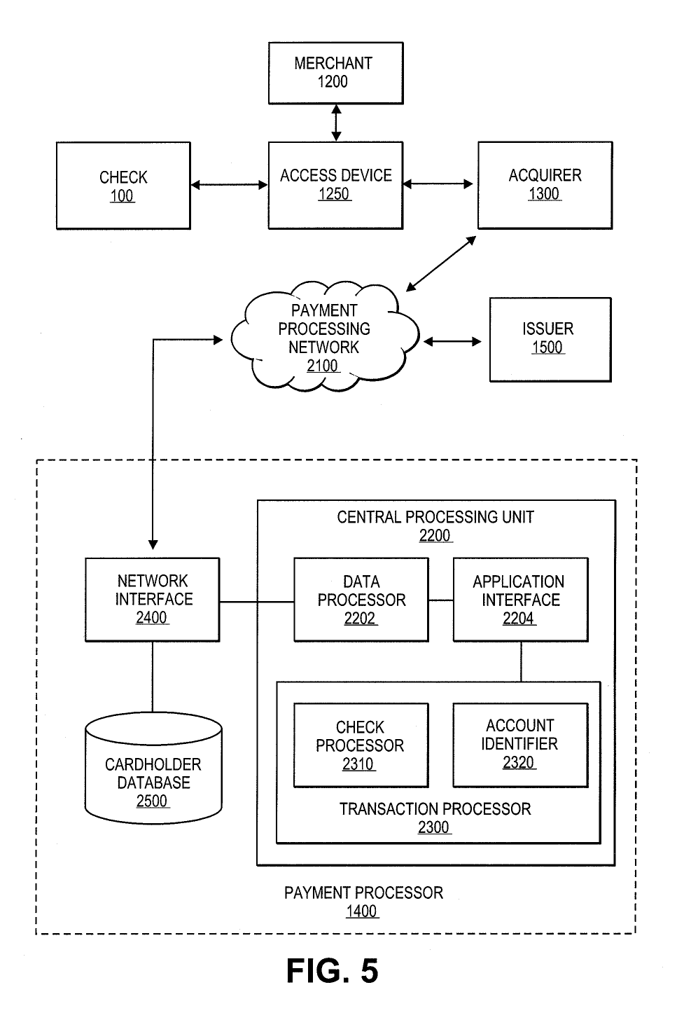

Embodiments of the invention will now be disclosed with reference to a block diagram of an exemplary real-time point-of-sale check approval system 2000 of FIG. 5, constructed and operative in accordance with an embodiment of the present invention.

As explained above, the merchant 1200 receives a check 100 from a user 50. An employee at the merchant 1200 may then take the check and may have MICR (magnetic ink character recognition) information on the check read by a reader in an access device 1250. The access device may comprise a reader for reading MICR information on the check, a card reader, a network interface, and a computer readable medium, all operatively coupled to a processor (e.g., a microprocessor). The access device 125 may then generate a transaction request message including demand account transaction data, which is forwarded to the acquirer 1300. In processing check 100, the acquirer 1300 sends the transaction request message to the payment processor 1400, which forwards it on to the issuer 1500 seeking approval. Acquirer 1300, payment processor 1400, and issuer 1500 communicate via a network 2100. Network 2100 may be any wide-area-network known in the art, and may use any networking technology known in the art. Examples of network technology include Transmission Control Protocol/Internet Protocol (TCP/IP), Ethernet, Fiber Distributed Data Interface (FDDI), token bus, or token ring networks. In some embodiments, the payment processing network 2100 may be configured to process credit and debit card transactions and may be located between a number of different issuers and acquirers. An example of a suitable payment processing network may be VisaNet.

The payment processor 1400 includes at least one central processing unit (CPU) 2200 (which may be an example of a transaction processor), a network interface 2400, and a cardholder database 2500. The payment processor 1400 may run a multi-tasking operating system (OS). The central processing unit 2200 may be any suitable central processing unit, microprocessor, micro-controller, computational device or circuit known in the art. Central processing unit 2200 may also comprise a server computer.

The central processing unit 2200 may be configured to correlate the user with the account holder record, and to generate an authorization request message including an issuer account identifier (e.g., a payment account number), the demand account identifier (e.g., a checking account number), and the transaction amount. It may also be configured to parse MICR line data from received transaction data, and generate an authorization request message including an issuer account identifier, a demand account identifier, and a transaction amount, and then send it to an issuer for approval. It may further be configured to convert an authorization response message from the issuer into a demand account response message (e.g., a point-of-service checking message) prior to forwarding it to an acquiring bank or merchant.

The cardholder database 2200 can be an example of an account holder database. An account holder database can be configured to contain an account holder record, the account holder record including first demand account information comprising a demand account identifier (e.g., a checking account number) for a demand account of a user and issuer account information comprising an issuer account identifier (e.g., a payment card number) of the user.

The network interface 2400 can be configured to receive demand account transaction data, including the demand account identifier and a transaction amount. It may also be configured to the network interface is further configured to transmit the authorization request message to an issuer for approval.

It is well understood by those in the art, that the functional elements of the central processing unit 2200 may be implemented in hardware, firmware, or as software instructions and data encoded on a computer-readable storage medium. As shown in FIG. 2, payment processor 1400 includes a central processing unit 2200. Further, although the payment processor 1400 is shown as being separate from the payment processing network 2100, in some embodiments, the payment processor 1400 and the payment processing network 2100 may be the same.

Central processing unit 2200 can be functionally comprised of a data processor 2202 (which may be embodied by a server computer), an application interface module 2204, and a transaction processor module 2300.

The transaction processor module 2300 may further comprise a check processor module 2310, and an account identifier module 2320. These structures may be implemented as hardware, firmware, or software encoded on a computer readable medium, such as storage media.

The central processing unit 2200 interfaces with cardholder database 2500 and network interface 2400. The central processing unit 2200 enables the payment processor 2200 to locate data on, read data from, and write data to, these components. The central processing unit 2200 may comprise a computer readable medium (not shown) coupled to the data processor 2202. The computer-readable storage medium may be encoded with data and instructions, such that when executed by data processor, the instructions causes the transaction processor to: receive a point-of-service checking transaction data via a data communications network, the point-of-service checking transaction data including the checking account of a user; correlate the user with an account holder record in an account holder database, the account holder record including a checking account of an account holder and payment card information of the account holder; populate the point-of-service checking transaction data with the payment card information; and, transmit, via a network interface, the revised point-of-service checking transaction data to a payment card issuer for approval

Application interface module 2204 may provide any suitable interface known in the art, which can allow for communication between the data processor 2202 and the transaction processor 1400.

Network interface module 2400 may provide any data port as is known in the art for interfacing, communicating or transferring data across a computer network. Network interface 2400 allows payment processor 1400 to communicate with issuer 1500, and may allow communication with acquirer 1300.

Cardholder database 2500 can be any suitable database that enables the payment processor 1400 to correlate an American Bankers Association number or Magnetic Ink Character Recognition data with a user's payment card data. Cardholder database 2500 may be stored on a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Computer-readable cardholder database 2500 may be remotely located from the central processing unit 2200, and be connected to the central processor unit 2200 via a network such as a local area network (LAN), a wide area network (WAN), or the Internet.

### III. Methods

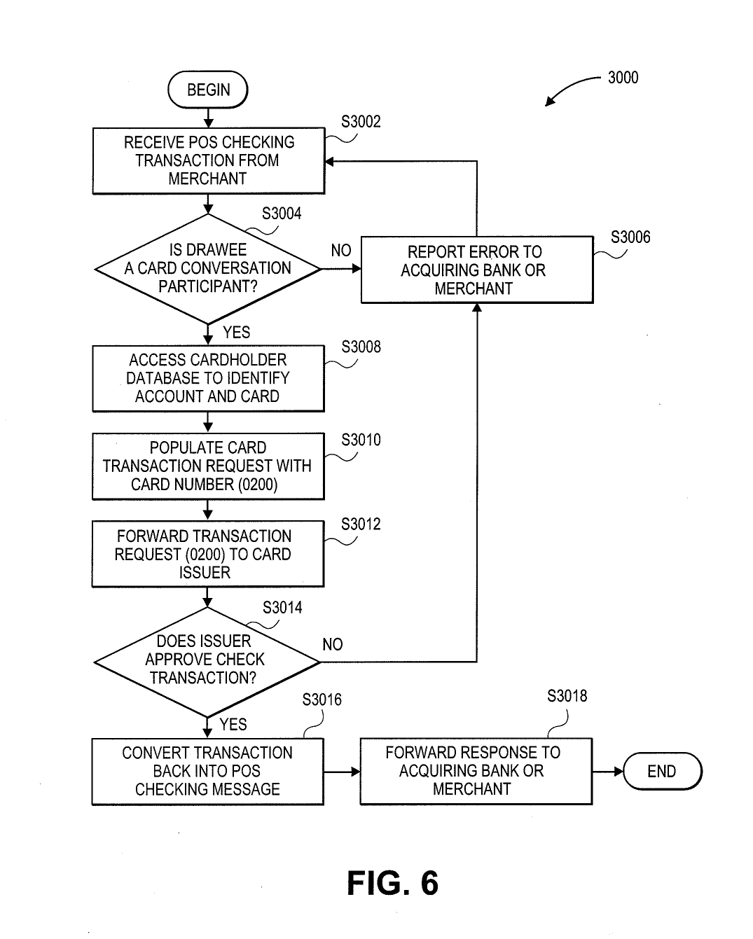

The function of these structures may best be understood with respect to the flowcharts of FIGS. 6-7, as described below.

FIG. 6 illustrates a flowchart of a process 3000 in which a payment processor 1400 is configured to facilitate real-time point-of-sale check approval, constructed and operative in accordance with an embodiment of the present invention.

One embodiment of the invention can be directed to a method. The method may comprise receiving demand account transaction data via a data communications network. The demand account transaction data includes a demand account identifier associated with a user and a transaction amount. The method also includes correlating the user with a cardholder record in a cardholder database, the cardholder record including a demand account identifier of the user and payment card information of the user. A payment card authorization request message including the payment card identifier, the demand account identifier, and the transaction amount is then generated and transmitted, via a network interface, to a payment card issuer for approval.

Initially, when a user 1100 presents a check 100 at a merchant 1200, the merchant 1200 scans the check 100 for the Magnetic Ink Character Recognition line using a suitable access device. The access device 1250 may comprise a network interface, a reader for reading data from the check, a processor and a computer readable medium coupled to the processor. A type of request (or the type of transaction indicator) indicator (e.g., a code) such as demand account transaction indicator such as a check-type transaction indicator, MICR information and the amount of the check can be transmitted as transaction data in a DDA authorization request message. Thus, in embodiments of the invention, normal POS check elements may be present in the transaction data. In some embodiments, the merchant 1200 may transmit the transaction data to payment processor 1400 directly, or in other embodiments, merchant 1200 may communicate the transaction data through an acquirer 1300.

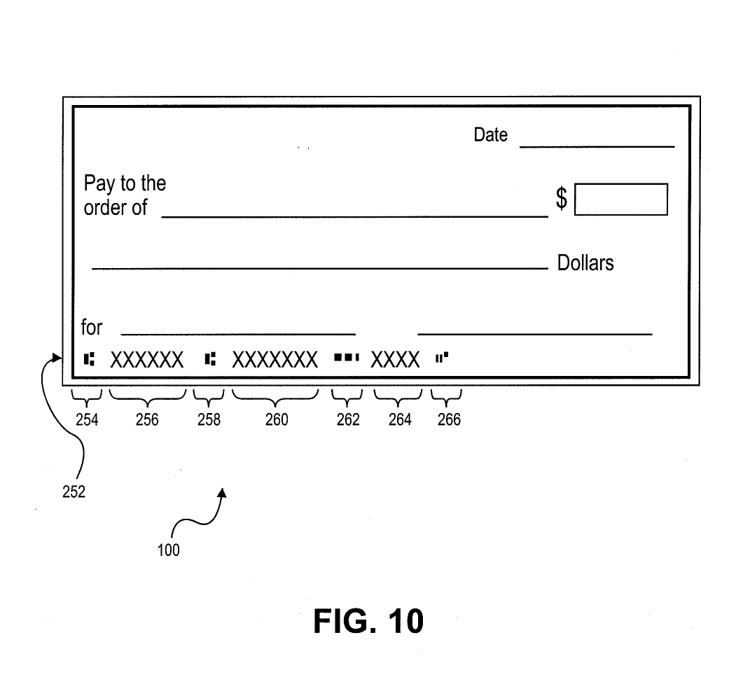

FIG. 10 is a more detailed illustration of paper check 100. The check 100 may be any suitable personal check or even other types of checks as permitted by law. On the lower edge of check 100 is a line of information 252 commonly termed the MICR (magnetic ink character recognition) data. Included within this line are separation characters 254, 258, 262 and 266 which separate the various pieces of information. Information 256 is a sequence of characters that is the transit routing number, also termed the ABA number. Information 260 is a sequence of characters identifying the customer's account number. Information 264 is a sequence of characters identifying the serial number of the check. As separators 254, 258, 262 and 266 are symbolic characters (also termed “nonprintable characters”), they are typically translated later into alphanumeric characters. When the separators in the MICR data are later translated into alphanumeric characters, they are typically translated to the characters “T”, “O”, “A” and “D” which is referred to as the raw TOAD format. Translation occurs because a computer systems cannot understand nonprintable characters, and this simple substitution allows the system (or another system) to eventually parse the information.

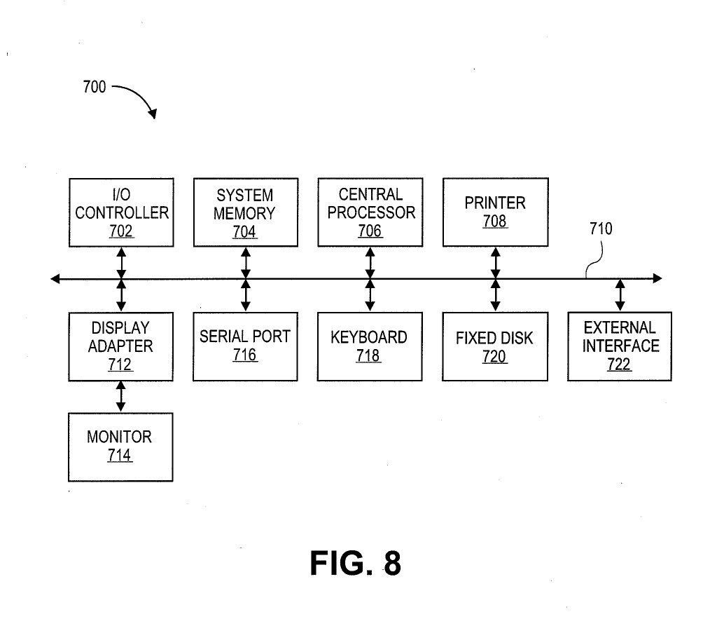

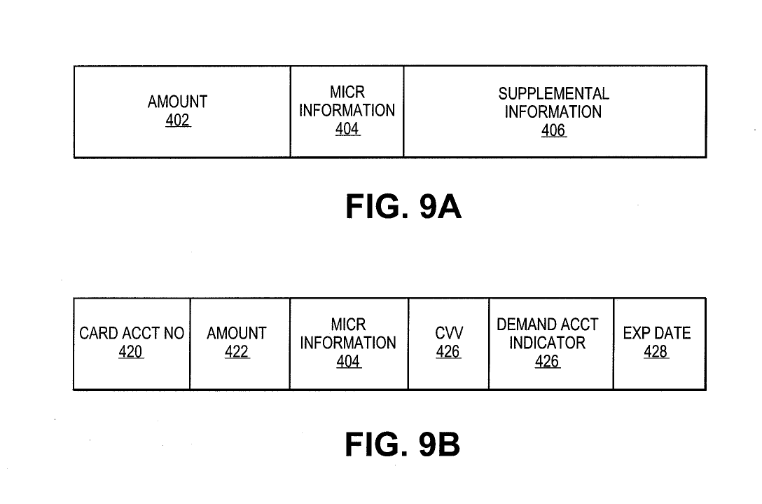

FIG. 9(a) shows an example of data elements that can be in demand account transaction data in a transaction request such as a DDA authorization request message. They include an amount 402, MICR information 404 including a check number and an account identifier, and optional supplemental information (e.g., authentication information such as a phone number, password, e-mail address, social security number, and/or driver's license number). More or less data elements may be included in the payment card authorization request message in other embodiments of the invention.

At block S3002, payment processor network interface 2400 receives the point-of-service checking transaction data.

Check processor module 2310 then determines whether the drawee is a card conversion participant, block S3004. (To simplify the example, we will assume that the drawee is the issuer 1500.) The determination may be accomplished through various different methods. In some embodiments, the Magnetic Ink Character Recognition line data may be examined to determine the financial institution affiliated with the check, and a determination may be made with that information. In other embodiments, it is possible to parse the American Bankers Association number from the transaction data and this information may be compared to data in the card database. Regardless of how the determination is made, if the check 100 is not a card conversion participant, as determined by the check processor 2310, an error is reported to the acquirer 1300 or merchant 1200, at block S3006.

If the drawee is a card conversion participant, account identifier 2320 correlates the checking account (parsed from the transaction data) with a specific cardholder by accessing a cardholder database 2500 at block S3008. Cardholder database 2500 indexes and stores cardholder information including a user's payment card number and checking account information. A user's payment card number may include a Primary Account Number (PAN). Usually, a user's Primary Account Number is either a 15 or 16 digit number. The first six digits of a Visa™ or MasterCard™ Primary Account Number identifies the card issuer banking institution 1400 and is known as the “Bank Identification Number” or “BIN.”

Note that in embodiments of the invention, the user's payment card number may be linked to any suitable account associated with the user, including a checking account, a money market account, savings account, etc. In embodiments of the invention, there can be a “many account” to “one card account” relationship. Thus, the user can use his payment card account to potentially use funds from many different banking accounts at the user's bank. Note also that in embodiments of the invention, the user has one or more DDA type accounts and also one or more payment card accounts with the same bank or issuer.

At block S3010, account identifier 2320 populates a card transaction request with the user's payment card number (0200) and places the parsed or non-parsed demand account number into a transaction message. The transaction message that is generated may be an authorization request message that is similar to the type used for normal credit or debit card transactions. However, the authorization request message may also include the transaction amount, issuer BIN, as well as a check type transaction indicator, which may include any suitable combination of numbers, letters, characters, etc. With the check type transaction indicator, the issuer will know that the transaction is a check type transaction, even though a card type transaction message is received.

FIG. 9(b) shows an example of a payment card authorization request message. It may include data elements including a card account number 420, an amount 422, MICR information 424, a CVV (card verification value), a demand account indicator 426, and an expiration date 428 for a card. More or less data elements may be included in the payment card authorization request message in other embodiments of the invention.

Check processor module 2310 forwards the transaction message to the card issuer 1500. The issuer receives the transaction request (0200), with a processing code that identifies the transaction as a check request (conversion, conversion with verification or guarantee) and an actual account number.

If the card issuer 1500 does not approve the checking transaction, an error is reported at block S3006. The checking transaction may be denied, for example, if there are insufficient funds in the account associated with the account number.

If the card issuer 1500 approves the checking transaction, a server computer at the issuer 1500 then generates an authorization response message. The authorization response message is then received at the payment processor 1400 via the network interface 2400. The central processing unit 2200 can convert the transaction data back into a POS check type response message (0200 with no card number), at block S3016. In some embodiments, the account identifier module 2320 generates a point-of-service checking response message. In other embodiments, the account identifier module 2320 repopulates the card transaction response with the MICR information.

The response message is then forwarded to the merchant 1200 or the acquirer 1200, via the payment processor 1400 at block S3018.

Referring to FIG. 7, process 4000 is method embodiment in which an issuer 1500 implements real-time point-of-sale check approval, constructed and operative in accordance with an embodiment of the present invention.

As discussed above, whenever a user uses check 100 to pay for a financial transaction, the merchant 1200, and, in turn, payment processor 1400 seek authorization from an issuer 1500 before performing the transaction. At block S4002, issuer 1500 receives an authorization request message from the merchant via the payment processor 1400. The authorization request message contains a formatted data packet or packets containing information about the requested transaction, such as transaction amount, merchant name, and the user's payment card number.

In some embodiments, the authorization request message may have been formatted by a POS terminal at the merchant, where the POS terminal obtains value account data (e.g., demand account data) from an initial value token (e.g., a check) and generates an authorization request message (e.g., a card type authorization request message) with the value account data in it as described above. Account linkage data may be retrieved from a (local or remote) cardholder database or the like. Thus, the POS terminal may perform many of the previously described functions of the central processing unit 2200 (which are incorporated herein). Further, although the payment processor 1400 is shown as being separate from an acquirer 1300 and the issuer 1500, the acquirer 1300 or an agent of the issuer 1500 could alternatively generate the authorization request message with the value account information in it in other embodiments.

At decision block S4004, the issuer 1500 after the issuer receives the authorization request message, it determines whether to approve the transaction. The transaction may be approved using any weighting any factors known in the art for payment card transaction. For example, in some instances, the issuer 1500 may treat the transaction as a checking or debit transaction; in other embodiments, issuer 1500 may evaluate the point-of-sale purchase as a credit purchase.

If it is not approved, a decline response message is forwarded to the merchant via the payment processor 1400, at block S4006.

If it is allowed, an approval response message is forwarded to the merchant to the payment processor 1400, block S4008.

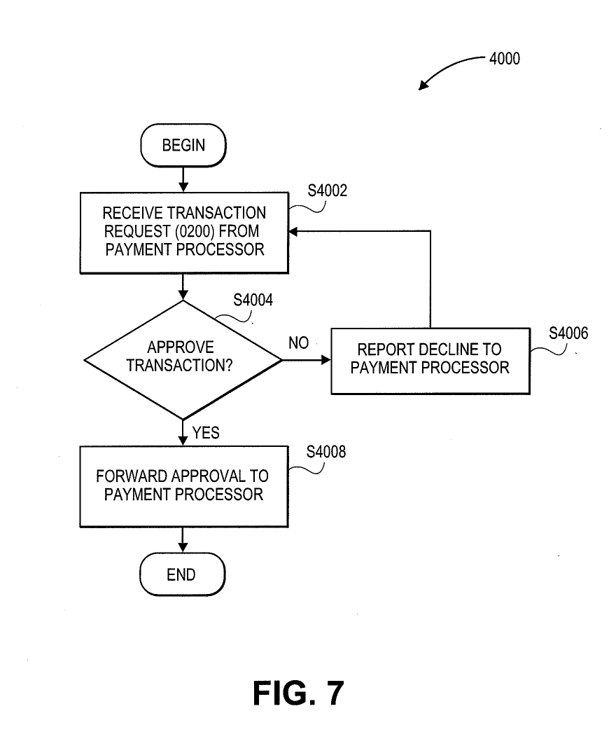

FIG. 8 shows a block diagram of an exemplary computer apparatus that can be used in some embodiments of the invention (e.g., in any of the components shown in the prior Figures).

The subsystems shown in FIG. 8 are interconnected via a system bus 710. Additional subsystems such as a printer 708, keyboard 718, fixed disk 720 (or other memory comprising computer readable media), monitor 714, which is coupled to display adapter 712, and others are shown. Peripherals and input/output (I/O) devices, which couple to I/O controller 702, can be connected to the computer system by any number of means known in the art, such as through serial port 716. For example, serial port 716 or external interface 722 can be used to connect the computer apparatus to a wide area network such as the Internet, a mouse input device, or a scanner. The interconnection via system bus 710 allows the central processor 706 to communicate with each subsystem and to control the execution of instructions from system memory 704 or the fixed disk 720, as well as the exchange of information between subsystems. The system memory 704 and/or the fixed disk 720 may embody a computer readable medium.

Embodiments of the invention have additional advantages. Conventional check approval is not authorization based, for the most part. It is negative file based. If one wants to increase POS check business, then one needs to get issuer participation. Embodiments of the invention make it much easier for issues to participate in check approval processes.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein. For example, although some specific embodiments describe the use of a message conversion process with typical brick and mortar type merchants, embodiments of the invention can also be used in on-line e-commerce type transactions.

Embodiments of the invention are not limited to the above-described embodiments. For example, although separate functional blocks are shown for an issuer, payment processing system, and acquirer, some entities perform all of these functions and may be included in embodiments of invention.

Further, additional embodiments of the invention may be directed to methods and systems involving merchants, and their access devices, as well as issues. For example, other embodiments may include the following additional embodiments.

Another embodiment may be directed to a method comprising generating, by an access device, a transaction request comprising demand account transaction data including a demand account identifier; sending the transaction request to a transaction processor, wherein the transaction processor generates an authorization request message comprising an issuer account identifier, the transaction amount, and the demand account identifier and sends it to an issuer for approval. The access device may further receive a transaction response from the issuer and the transaction processor. Other embodiments may relate to the access device that performs the method.

Yet another embodiment may be directed to a method comprising, receiving, by a computer apparatus at an issuer, an authorization request message comprising an issuer account identifier, a demand account identifier, and a transaction amount; and generating an authorization response message indicating whether the a transaction conducted using the demand account identifier is approved or not approved. The issuer computer apparatus may also be configured to determine if a demand account indicator is in the authorization request message.

It should be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CDROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary. A recitation of “she” is meant to be gender neutral, and may be read as “he” or “she”, unless specifically indicated to the contrary.

All patents, patent applications, publications, and descriptions mentioned above are herein incorporated by reference in their entirety for all purposes. None is admitted to be prior art.

What is claimed is:

1. An apparatus comprising:
an account holder database configured to contain an account holder record, the account holder record including value account information comprising a value account identifier for a value account of a user and issuer account information comprising an issuer account identifier of the user;
a network interface configured to receive value account transaction data, the value account transaction data including the value account identifier and a transaction amount; and
a transaction processor configured to correlate the user with the account holder record, and to generate an authorization request message including the issuer account identifier, the value account identifier and the transaction amount; and,
wherein the network interface is further configured to transmit the authorization request message to an issuer for approval.

2. The apparatus of claim 1 wherein the value account is a first account and the value account identifier is a first value account identifier, wherein the account holder record further comprises a second value account identifier associated with the user, wherein both the first and the second value account identifiers are linked to the issuer account identifier, wherein the issuer account identifier is a payment card account number.

3. The apparatus of claim 1 wherein the authorization request message is a payment card authorization request message and further comprises a value account transaction indicator.

4. The apparatus of claim 1 wherein the value account is a demand account.

5. The apparatus of claim 1 wherein the issuer account identifier is associated with a payment card account number for a payment card, wherein the payment card is a credit card.

6. A method comprising:
receiving value account transaction data via a data communications network, the value account transaction data including a value account identifier associated with a value account of a user and a transaction amount;
correlating the user with an account holder record in an account holder database, the account holder record including a value account identifier of the user and issuer account information comprising an issuer account identifier of the user;
generating an authorization request message including the issuer account identifier, the value account identifier, and the transaction amount; and
transmitting, via a network interface, the authorization request message to an issuer for approval.

7. The method of claim 6 wherein the value account is a first account and the value account identifier is a first value account identifier, wherein the account holder record further comprises a second value account number associated with the user, wherein both the first and the second value account numbers are linked to the issuer account identifier, wherein the issuer account identifier is a payment card account number.

8. The method of claim 6 wherein the authorization request message is a payment card authorization request message and further comprises a value account transaction indicator.

9. The method of claim 6 wherein the value account is a demand account.

10. The method of claim 6 wherein the payment card is a credit card.

11. A real-time point-of-sale approval apparatus comprising:
an account holder database configured to contain an account holder record, the account holder record including a checking account of an account holder and payment card information of the account holder;
a network interface configured to receive point-of-service checking transaction data, the point-of-service checking transaction data including the checking account of a user; and
a transaction processor configured to correlate the user with the account holder record, to populate the point-of-service checking transaction data with the payment card information; and,
wherein the network interface is further configured to transmit the revised point-of-service checking transaction data to a payment card issuer for approval.

12. The real-time point-of-sale check approval apparatus of claim 11, wherein the network interface is further configured to:
receive a transaction response from the issuer.

13. The real-time point-of-sale check approval apparatus of claim 12, wherein the network interface is further configured to:
forward the transaction response to an acquiring bank or a merchant.

14. The real-time point-of-sale check approval apparatus of claim 13, wherein the payment card information of the account holder is a Primary Account Number.

15. The real-time point-of-sale check approval apparatus of claim 14, wherein the point-of-service checking transaction data includes Magnetic Ink Character Recognition (MICR) line data.

16. The real-time point-of-sale check approval apparatus of claim 15, wherein the transaction processor is further configured to parse the MICR line data from the point-of-service checking transaction data.

17. The real-time point-of-sale check approval apparatus of claim 15, wherein the transaction processor is further configured to convert the transaction response to a point-of-service checking message prior to forwarding to the acquiring bank or the merchant.

18. A real-time point-of-sale check approval method comprising:
receiving a point-of-service checking transaction data via a data communications network, the point-of-service checking transaction data including the checking account of a user;
correlating the user with an account holder record in an account holder database, the account holder record including a checking account of an account holder and payment card information of the account holder;
populating the point-of-service checking transaction data with the payment card information; and,
transmitting, via a network interface, the revised point-of-service checking transaction data to a payment card issuer for approval.

19. The real-time point-of-sale check approval method of claim 18, further comprising:
receiving a transaction response from the issuer via the network interface.

20. The real-time point-of-sale check approval method of claim 19, further comprising:
forwarding the transaction response to an acquiring bank or a merchant via the network interface.

21. The real-time point-of-sale check approval method of claim 20, wherein the payment card information of the account holder is a Primary Account Number.

22. The real-time point-of-sale check approval method of claim 21, wherein the point-of-service checking transaction data includes Magnetic Ink Character Recognition (MICR) line data.

23. The real-time point-of-sale check approval method of claim 22, further comprising:
parsing the MICR line data from the point-of-service checking transaction data.

24. The real-time point-of-sale check approval method of claim 23, further comprising:
converting the transaction response to a point-of-service checking message prior to forwarding to the acquiring bank or the merchant.

25. A computer-readable storage medium, encoded with data and instructions, such that when executed by a device, the instructions causes the device to:
receive a point-of-service checking transaction data via a data communications network, the point-of-service checking transaction data including the checking account of a user;
correlate the user with an account holder record in an account holder database, the account holder record including a checking account of an account holder and payment card information of the account holder;
populate the point-of-service checking transaction data with the payment card information; and,
transmit, via a network interface, the revised point-of-service checking transaction data to a payment card issuer for approval.

26. The computer-readable storage medium of claim 25, the instructions causing the device to:
receive a transaction response from the issuer via the network interface.

27. The computer-readable storage medium of claim 26, the instructions causing the device to:
forward the transaction response to an acquiring bank or a merchant via the network interface.

28. The computer-readable storage medium of claim 27, wherein the payment card information of the account holder is a Primary Account Number.

29. The computer-readable storage medium of claim 28 wherein the point-of-service checking transaction data includes Magnetic Ink Character Recognition (MICR) line data.

30. The computer-readable storage medium of claim 19, the instructions causing the device to:
parse the MICR line data from the point-of-service checking transaction data.
